(19) United States
(12) Patent Application Publication
(10) Pub. No.: US 2004/0112338 A1
(43) Pub. Date: Jun. 17, 2004

(54) Fuel injection system

(76) Inventors: Werner Berger, Markgroeningen (DE); Martin Mueller, Moeglingen (DE); Andreas Glaser, Stuttgart (DE); Anh Tuan Hoang, Tamm (DE); Martin Buehner, Backnang (DE); Cedric Olivier, Ludwigsburg (DE)

Correspondence Address: KENYON & KENYON, ONE BROADWAY, NEW YORK, NY, 10004, US

(21) Appl. No.: 10/470,521

(22) PCT Filed: Aug. 23, 2002
(86) PCT No.: PCT/DE02/03096

(30) Foreign Application Priority Data
Nov. 30, 2001 (DE) 10158788.0

(51) Int. Cl. F02M 55/02

(52) U.S. Cl. 123/468

(57) ABSTRACT

A fuel injection system for injecting fuel into an internal combustion engine, including at least one fuel injector (2) and a fuel rail, has, for each fuel injector (2), an intake (6) connectible to an intake section (9) of the fuel injector (2). A corrugated tube (3, 21) is arranged between the intake (6) of the fuel rail and the intake section (9) of the fuel injector (2). The corrugated tube (3, 21) has two identical end sections (4a, 4b) that are able to be brought together concentrically with guide sections (5a, 5b) of the intake section (9) of the fuel injector (2) and of the intake (6) of the fuel rail. Sealing means (17) are undetachably arranged at the end sections (4a, 4b).

### BACKGROUND INFORMATION

The present invention starts from a fuel injection system for injecting fuel into an internal combustion engine according to the generic part of the main claim.

A fuel injection system for supplying fuel to a mixture-compressing internal combustion engine with external ignition as a function of operating characteristics is known from the German laid open print 28 29 057. The fuel injection system includes a metal fuel rail connected via at least one branch line to at least one fuel injector, the branch line being designed as a metal tube and being connected to the fuel injector by a screw connection. A readily bendable metal is used as branch line material. Provided between the screw connection on the branch line and the fuel injector is a metallic, thin-walled bellows in the form of a corrugated tube bellows, by which a lateral offset between the starting point of the branch line at the fuel rail and the fitting position of the fuel injector is compensated.

A drawback in the fuel injection system known from DE-OS 28 29 057 is that the screw connection requires special forms of the corrugated tube bellows. A particular drawback is that the corrugated tube bellows is not releasably connected to the screw connection or the fuel rail. Simple, rapid assembly of the fuel rail is hampered.

A tube line connection in the form of a corrugated tube that is supposed to inhibit or prevent transfer of vibration is known from U.S. Pat. No. 2,014,355. The corrugated tube is surrounded on the outside by a sleeve that does not touch the corrugated tube and is rigidly connected on one end to the one tube section. On its other end, the sleeve is sealed with respect to the other tube section by a flexible seal. A flange of a retaining nut is force-fit into the corrugation situated in each case at the end of the corrugated tube. The corrugated tube is fastened to adjacent tube sections by the retaining nut.

A disadvantage of the known related art is that the arrangement has multiple parts and does not permit rapid, simple assembly.

### SUMMARY OF THE INVENTION

The fuel injection system according to the present invention having the characterizing features of the main claim, on the other hand, has the advantage that the corrugated tube is designed as a simple, universally employable component that may be mounted by insertion. Due to the pressure force of the sealant on a sealing line, preassembly is also possible, in which the corrugated tube according to the invention is already inserted into the intake of the fuel rail and connected to it, together with the fuel injectors. The corrugated tube according to the invention may be manufactured cost-effectively and may be used for a variety of different fuel injection systems.

The measures specified in the dependent claims permit advantageous modifications and improvements of the fuel injection system indicated in the main claim.

The end sections are advantageously enclosed radially on the outside by the guide sections, and the guide sections have a conical entry region.

The sealing device may be made of an elastomer ring supported against a support ring and disposed in a groove.

An elastomer ring is advantageously secured in simple fashion by its inherent tension in a groove.

A locking plate arranged on the guide section advantageously engages in a first corrugation of the corrugated tube.

Loss of the corrugated tube is thereby prevented during subsequent disassembly.

At each end section, the first corrugation of the corrugated tube advantageously lies against a grading of the intake, and, correspondingly, of the intake section.

By the guidance at the guide sections, with appropriate design of the corrugated tube, the hold-down force for the fuel injector may be exerted via the corrugated tube, since lateral sliding is prevented. In so doing, the seal is not stressed by the hold-down force.

### BRIEF DESCRIPTION OF THE DRAWING

Exemplary embodiments of the present invention are shown in simplified fashion in the drawing and explained further in the following description. In the drawing:

FIG. 1 shows a partially cutaway view of a first exemplary embodiment of a fuel injection system according to the present invention in the plane of a fuel injector and a corrugated tube; and

FIG. 2 shows an exemplary embodiment of the fuel injection system according to the present invention having a locking plate, in the same view as in FIG. 1.

### DESCRIPTION OF THE EXEMPLARY EMBODIMENTS

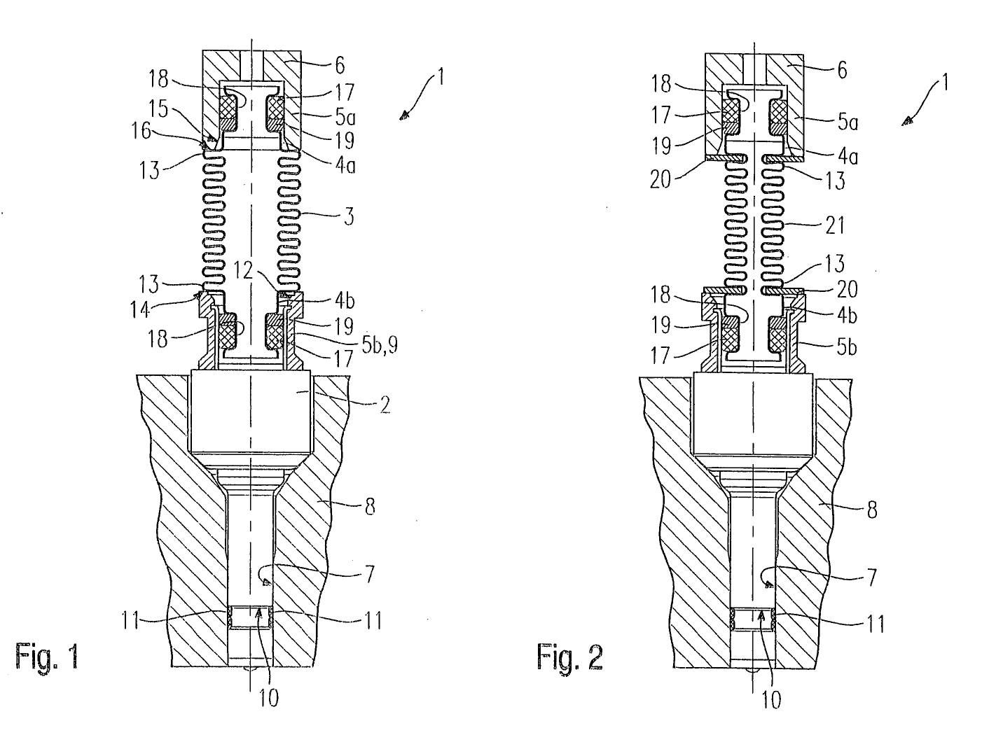

FIG. 1 shows a partially cutaway view of a first exemplary embodiment of a fuel injection system 1 according to the invention in the plane of a fuel injector 2 and a corrugated tube 3. Corrugated tube 3, shown in a cutaway view, is introduced with a first end section 4a of two identically designed end sections 4a, 4b into a first guide section 5a of an intake 6 of a fuel rail (not shown here). Second end section 4b is introduced into a second guide section 5b formed on an intake section 9 of fuel injector 2.

Fuel injector 2 is inserted into a bore hole 7 of a cylinder head 8 of an internal combustion engine and is shown in a cutaway view in the region of intake section 9. Fuel injector 2 is sealed with respect to bore hole 7 by a sealing ring 11 made, for example, of elastomer, arranged in a groove 10.

A conical entry section 12 is formed on intake section 9. A corrugation 13, initially connecting to (being next to) second end section 4b, lies against a grading 14 of intake section 9. A conical entry section 15 is also formed on intake 6. A corrugation 13, initially connecting to first end section 4a, lies against a grading 16 of intake 6. Each end section 4a, 4b is sealed with respect to corresponding guide section 5a, 5b by a sealing ring 17 made of elastomer. Sealing ring 17 is positioned in a groove 18 and supported by a support ring 19.

Corrugated tube 3 of fuel injection system 1 according to the present invention may advantageously always be identically constructed for use with fuel injection systems 1 adapted to different installation conditions, and may therefore be produced cost-effectively as a mass-produced part. Simple assembly by insertion is possible, corrugated tube 3 being held against intake 6 or intake section 9 during subsequent assembly by the deformation tension of sealing ring 17 with respect to guide sections 5a, 5b. In particular, because of its symmetrical design, it is impossible to insert corrugated tube 3 the wrong way round. However, an unsymmetrical design or a fixed connection between fuel injector 2 and corrugated tube 3, for example, by laser welding, is also possible.

By a suitably rigid design of corrugated tube 3, it is possible via gradings 14, 16 to exert a hold-down force from the fuel rail onto fuel injector 2, which holds fuel injector 2 down in bore hole 7 against the combustion pressure. Special hold-down devices may thereby be eliminated. Sealing of corrugated tube 3 with respect to guide sections 5a, 5b is not adversely influenced by the hold-down tension.

FIG. 2 shows another exemplary embodiment of a fuel injection system 1 according to the present invention having a locking plate 20, in the same view as the corresponding fuel injection system in FIG. 1. Corresponding components are provided with the same reference numerals. A corrugated tube 21, shown in a cutaway view, has a smaller diameter compared to the corrugated tube depicted in FIG. 1. First end section 4a is inserted into first guide section 5a of intake 6 of the fuel rail (not shown here), and second end section 4b is inserted into second guide section 5b of fuel injector 2. Each end section 4a, 4b is sealed by sealing ring 17, arranged in groove 18 and supported by support ring 19, with respect to corresponding guide sections 5a, 5b.

Fuel injector 2 is inserted in bore hole 7 of cylinder head 8 of the internal combustion engine and is sealed by elastomer sealing ring 11 disposed in groove 10.

Corrugation 13, initially connecting to respective end section 4b, lies against corresponding locking plate 20.

Not only is a hold-down force transferred by locking plate 20, but respective end sections 4a, 4b are also prevented from sliding out of corresponding guide sections 5a, 5b. If only one of locking plates 20 is removed during disassembly, corrugated tube 21 is held with its other end section 4a, 4b against the fuel rail or fuel injector 2, and cannot be lost.

What is claimed is:

1. A fuel injection system for injecting fuel into an internal combustion engine comprising at least one fuel injector (2) and a fuel rail, which, for each fuel injector (2), has an intake (6) that is connectible to an intake section (9) of the fuel injector (2), a corrugated tube (3, 21) being arranged between the intake (6) and the intake section (9) of the fuel injector (2), wherein the corrugated tube (3, 21) has two end sections (4a, 4b) that are able to be brought together concentrically with guide sections (5a, 5b) of the intake section (9) of the fuel injector (2) on the one side, and of the intake (6) of the fuel rail on the other side; and sealing means (17) are undetachably arranged at the end sections (4a, 4b).

2. The fuel injection system as recited in claim 1, wherein the end sections (4a, 4b) are enclosed radially on the outside by the guide sections (5a, 5b).

3. The fuel injection system as recited in claim 2, wherein the guide sections (5a, 5b) have a conical entry section (12, 15).

4. The fuel injection system as recited in one of claims 1 through 3, wherein the sealing means are made in each case of an elastomer ring (17) arranged in a groove (18).

5. The fuel injection system as recited in claim 4, wherein the elastomer rings (17) are supported against a support ring (19).

6. The fuel injection system as recited in one of claims 1 through 3, wherein the sealing means (17) are made of an elastomer glued to the end sections (4a, 4b).

7. The fuel injection system as recited in one of claims 1 through 6, wherein a locking plate (20) arranged on each guide section (5a, 5b) engages in a first corrugation (13) of the corrugated tube (21).

8. The fuel injection system as recited in one of claims 1 through 7, wherein at each end section (4a, 4b), the first corrugation (13) of the corrugated tube (3) lies in each instance against a grading (14, 16) of the intake (6) of the fuel rail, as well as, correspondingly, of the intake section (9) of the fuel injector (2).
